(19) United States
(12) Patent Application Publication
(10) Pub. No.: US 2026/0254343 A1
(43) Pub. Date: Aug. 27, 2026

(54) SEMICONDUCTOR DEVICE AND POWER CONVERSION APPARATUS

(71) Applicant: Mitsubishi Electric Corporation, Tokyo (JP)

(72) Inventors: Shotaro YAMAMOTO, Chiyoda-ku, Tokyo (JP); Yukihiko WADA, Chiyoda-ku, Tokyo (JP); Yoshiko TAMADA, Chiyoda-ku, Tokyo (JP); Kenichi MOROKUMA, Chiyoda-ku, Tokyo (JP); Tomokazu MARUYAMA, Chiyoda-ku, Tokyo (JP); Ayaki IKEJIRI, Chiyoda-ku, Tokyo (JP)

(73) Assignee: Mitsubishi Electric Corporation, Tokyo (JP)

(21) Appl. No.: 18/995,188

(22) PCT Filed: Jul. 22, 2022
(86) PCT No.: PCT/JP2022/028435

§ 371 Date: Jan. 16, 2025

(51) Int. Cl. H02M 1/08; H02M 1/38; H02M 7/537

(52) U.S. Cl. CPC H02M 1/08; H02M 1/38; H02M 7/537

(57) ABSTRACT

A semiconductor device includes a gate voltage control circuit that applies an on-bias voltage and an off-bias voltage to a gate terminal of a power semiconductor element in accordance with a first drive signal, and an off-bias voltage control circuit that adjusts a voltage level of the off-bias voltage in accordance with the first drive signal and a second drive signal and controls a period of applying the adjusted off-bias voltage.

### TECHNICAL FIELD

The present disclosure relates to a semiconductor device, and more particularly, to the driving of a power semiconductor element.

### BACKGROUND ART

One of the problems related to the reliability of a power semiconductor element is a gate false turn-on. When a gate false turn-on occurs, the high-voltage power supply on the upper arm and the low-voltage power supply on the lower arm of one phase of a power inverter in which the false turn-on occurs are short-circuited. As a result, a large short-circuit current flows between the power supplies, which may increase electrical loss of the power inverter, and may lead to a thermal runaway in the worst case.

As a countermeasure against the gate false turn-on, there is widely known an approach of applying a negative bias voltage between the gate and the source of a power semiconductor element. The gate false turn-on is caused by a displacement current generated by the turn-on operation of the power semiconductor element on the opposing arm. Since the displacement current is proportional to the voltage change rate of the power conversion element on the opposing arm, the displacement current increases as the switching speed becomes higher, and as a result, the false turn-on of the switching-side element is likely to occur. However, when a negative bias voltage is applied at a timing when a false turn-on occurs, it is possible to prevent a short circuit from occurring in the upper and lower arm elements without exceeding the gate threshold voltage, and the larger the negative bias voltage is, the greater the effect of preventing the false turn-on will be.

On the other hand, when a negative bias voltage is applied between the gate and the source, during the OFF operation of a conventional power semiconductor element, the gate is driven with a constant application of the negative bias voltage. When the negative bias has been applied for a long period of time, the gate oxide film of the power semiconductor element suffers from a stress. In a report on a silicon nitride-based metal oxide semiconductor field effect transistor (SiC-MOSFET: Metal-Oxide-Semiconductor Field-Effect Transistor), it was reported that a great stress on the gate oxide film may cause characteristic degradation or failure of a power semiconductor element. As a result, the entire reliability of the power inverter is reduced.

### CITATION LIST

### Patent Literature

PTL 1: Japanese Patent Laying-Open No. 2013-219874

### Non Patent Literature

NPL 1: Andreas Marz, et al., Comparison of SiC MOSFET gate-drive concepts to suppress parasitic turn-on in low inductance power modules, EPE, 2017.

### SUMMARY OF INVENTION

### Technical Problem

In PTL 1, the gate terminal of the power semiconductor element is applied with two voltages, i.e., a first voltage and a second voltage lower than the first voltage. The turn-off operation of the power semiconductor device is performed at the first voltage, but the first voltage is generally not greater than the negative bias voltage applied to the gate terminal. In other words, the switching loss of the power semiconductor element increases as compared with the case when the second voltage is used. On the other hand, when the first voltage is increased, the switching loss is improved by speeding up the turn-on operation, but a negative bias voltage (for example, the second voltage) greater than the first voltage must be continuously applied to the gate until the end of the turn-on operation of the power semiconductor element on the opposing arm, including a dead time after the turn-off operation. Therefore, this leads to the aforementioned problem of stress on the gate oxide film, which reduces the entire reliability of the power converter.

In NPL 1, a negative bias voltage is applied to the gate terminal of a self-arm element over a period from the start of the turn-off operation of the power semiconductor element to the end of the turn-on operation of the power semiconductor element on the opposing arm. In other words, the negative bias voltage is continuously applied to the gate terminal of the self-arm element during the dead time period and the switching period. Therefore, in a system or the like in which the dead time is set to a large value, there is a concern that the effect of reducing the stress on the gate oxide film may be insufficient.

It is an object of the present disclosure to provide a semiconductor device and a power conversion apparatus capable of improving the reliability of a power semiconductor element.

### Solution to Problem

A semiconductor device according to an embodiment includes: a gate voltage control circuit that applies an on-bias voltage and an off-bias voltage to a gate terminal of a power semiconductor element according to a first drive signal; and an off-bias voltage control circuit that adjusts a voltage level of the off-bias voltage according to the first drive signal and a second drive signal and controls a period of applying the adjusted off-bias voltage.

A power conversion apparatus according to an embodiment includes: a first power semiconductor element; a second power semiconductor element provided on an opposing arm which is connected in series to the first power semiconductor element; a first gate drive circuit provided for the first power semiconductor element and configured to drive the first power semiconductor element according to a first drive signal; and a second gate drive circuit provided for the second power semiconductor element and configured to drive the second power semiconductor element according to a second drive signal. Each of the gate drive circuits includes: a gate voltage control circuit that applies an on-bias voltage and an off-bias voltage to a gate terminal of a corresponding power semiconductor element according to a corresponding drive signal; and an off-bias voltage control circuit that adjusts a voltage level of an off-bias voltage according to the first and second drive signals and controls a period of applying the adjusted off-bias voltage.

### Advantageous Effects of Invention

According to the semiconductor device and the power conversion apparatus of the present disclosure, it is possible to improve the reliability of a power semiconductor element.

### BRIEF DESCRIPTION OF DRAWINGS

FIG. 1 is a block diagram illustrating a gate drive circuit 100 of a power semiconductor device according to a first embodiment;

FIG. 2 is a diagram illustrating a specific configuration of a first control circuit 21 and a second control circuit 31 according to the first embodiment;

FIG. 3 is a diagram illustrating a timing chart when the gate drive circuit 100 according to the first embodiment controls the gate of a power semiconductor element 10;

FIG. 4 is a diagram illustrating a gate drive circuit 101 according to a second embodiment;

FIG. 5 is a diagram illustrating a timing chart when the gate drive circuit 101 according to the second embodiment controls the gate of a power semiconductor element;

FIG. 6 is a block diagram illustrating a gate drive circuit 100 # of a power semiconductor device according to a third embodiment;

FIG. 7 is a diagram illustrating a specific configuration of a first control circuit 21 # and a second control circuit 31 # according to the third embodiment;

FIG. 8 is a diagram illustrating a waveform of a gate voltage Vgs of a SiC-MOSFET to which the gate drive circuit 100 of the present disclosure is applied;

FIG. 9 is a diagram illustrating a timing chart when a gate drive circuit 101 according to a fifth embodiment controls the gate of the power semiconductor element;

FIG. 10 is a block diagram illustrating an integrated drive circuit 102 according to a sixth embodiment; and

FIG. 11 is a block diagram illustrating a configuration of a power conversion system according to a seventh embodiment.

### DESCRIPTION OF EMBODIMENTS

### First Embodiment

Hereinafter, a gate drive circuit of a power semiconductor device, which is an example of the present disclosure, will be described.

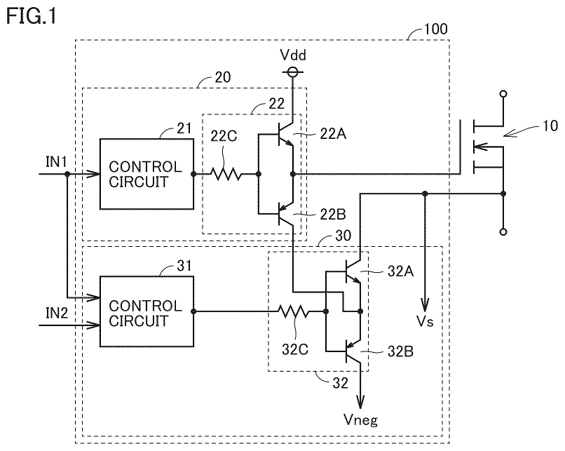

FIG. 1 is a block diagram illustrating a gate drive circuit 100 according to a first embodiment.

With reference to FIG. 1, the gate drive circuit 100 controls the gate of a power semiconductor element 10 connected between DC high-voltage power supplies according to the input of an external drive signal IN1 and an external drive signal IN2. Specifically, the gate drive circuit 100 controls an on/off operation, i.e., a switching operation of the power semiconductor element 10.

The power semiconductor element 10 corresponds to a switching element of a main circuit in an inverter circuit of a power conversion apparatus. For example, the power semiconductor element 10 is an element of a 2-in-1 half bridge circuit, a 4-in-1 full bridge circuit, or a 6-in-1 three-phase inverter. In these circuit configurations, since the output voltage of the inverter is generated according to a PWM control, a high voltage of several hundred volts or more is applied between the drain and the source of the element during the OFF operation. In addition, a large current flows through the element during the ON operation according to the system of the power conversion apparatus. In these operation states, the gate voltage for turning on or turning off the power semiconductor element 10 is controlled according to the external drive signal IN1.

The gate drive circuit 100 includes a gate voltage control circuit 20 and an off-bias voltage control circuit 30.

The gate voltage control circuit 20 controls an on-bias voltage and an off-bias voltage of the gate of the power semiconductor element 10.

The gate voltage control circuit 20 includes a first control circuit 21 and a first switching circuit 22.

The first control circuit 21 controls a gate control signal so that a desired switching operation of the power semiconductor element 10 is performed according to the input external drive signal IN1. Specifically, the gate control signal is set to “1” during a period when the power semiconductor element 10 should be turned on, and the gate control signal is set to “0” during a period when the power semiconductor element 10 should be turned off. These binary voltage signals can be obtained by generating a pulse wave using a communication signal source such as a 5V system or a 3.3V system in a logic circuit.

The first switching circuit 22 is disposed between the gate of the power semiconductor element 10 and the first control circuit 21. The high side of the first switching circuit 22 is connected to a positive voltage source Vdd, and the low side thereof is connected to a second switching circuit 32.

The first switching circuit 22 includes an NPN transistor 22A, a PNP transistor 22B, and a resistance element 22C.

The NPN transistor 22A and the PNP transistor 22B are connected in series.

The NPN transistor 22A is connected to the positive voltage source Vdd, and is connected to an output node.

The PNP transistor 22B is connected to the output node and an output node of the second switching circuit 32.

The gate of the NPN transistor 22A and the gate of the PNP transistor 22B are connected to the first control circuit 21 via the resistance element 22C.

The first switching circuit 22 can switch the current path according to a gate control signal output from the first control circuit 21. As a result, the current path through which the gate current flows in the power semiconductor element 10 is changed, which is equivalent to switching between gate charging and gate discharging. Therefore, the first switching circuit 22 switches a gate voltage to be applied to the gate of the power semiconductor element 10 to control the on/off operation of the power semiconductor element 10.

The off-bias voltage control circuit 30 controls the voltage level of an off-bias voltage applied to the gate during the OFF operation of the power semiconductor element 10 according to the external drive signal IN1 and the external drive signal IN2. Specifically, the off-bias voltage control circuit 30 sets the voltage level during the off operation of the power semiconductor element 10 to always be below 0 V because if the voltage level is a positive value, it may exceed the gate threshold voltage of the power semiconductor element 10.

In addition, the number of voltage levels of the off-bias voltage to be switched is two, for example.

In the present embodiment, the external drive signal IN1 and the external drive signal IN2 are used to switch the two voltage levels of the off-bias voltage. The external drive signal IN1 is the same as the input signal to the first control circuit 21.

The external drive signal IN2 is required to provide the gate drive circuit 100 with time information of a gate false turn-on (also referred to as a self-turn-on phenomenon) of the power semiconductor element 10, which will be described later. The external drive signal IN2 is provided as a means different from the external drive signal IN1.

The off-bias voltage control circuit 30 includes a second control circuit 31 and a second switching circuit 32.

The second control circuit 31 outputs an off-bias voltage control signal capable of arbitrarily adjusting a voltage level of an off-bias voltage applied to the gate of the power semiconductor element 10 and an application period of the off-bias voltage based on the input of the external drive signal IN1 and the external drive signal IN2. A specific scheme will be described later.

The second switching circuit 32 is connected to the second control circuit 31, the first switching circuit 22, and the source electrode of the power semiconductor element 10.

The high side of the second switching circuit 32 is connected to a source electrode of the power semiconductor element 10, and the low side thereof is connected to a negative voltage source Vneg.

The second switching circuit 32 includes an NPN transistor 32A, a PNP transistor 32B, and a resistance element 32C.

The NPN transistor 32A and the PNP transistor 32B are connected in series.

The NPN transistor 32A is connected to the source electrode of the power semiconductor element 10 and is connected to an output node. The output node is connected to the first switching circuit 22.

The PNP transistor 32B is connected to the output node and the negative voltage source Vneg.

The gate of the NPN transistor 32A and the gate of the PNP transistor 32B are connected to the second control circuit 31 via the resistance element 32C.

The second switching circuit 32 switches the off-bias voltage level of the gate according to an off-bias voltage control signal generated by the second control circuit 31. Specifically, the second switching circuit switches a reference potential Vs which is based on the source potential of the power semiconductor element 10 and the negative voltage source Vneg are switched. In other words, the voltage level of an off-bias voltage to be applied to the gate of the power semiconductor element 10 is switched by switching the source potential of the power semiconductor element 10.

Hereinafter, the state in which the reference potential Vs is connected may be referred to as a “shallow off-bias voltage”, and the state in which the negative voltage source Vneg is connected may be referred to as a “deep off-bias voltage” where appropriate.

However, the shallow off-bias voltage and the deep off-bias voltage applied to the gate of the power semiconductor element 10 are premised on the OFF operation of the power semiconductor element 10. Therefore, the shallow off-bias voltage and the deep off-bias voltage to be applied to the gate of the power semiconductor element 10 are not uniquely determined by the operation of the second switching circuit 32, but switched by the first switching circuit 22 only during the OFF operation of the power semiconductor element 10. In other words, the voltage level of the off-bias voltage applied to the gate of the power semiconductor element 10 is controlled based on the state of the gate voltage control circuit 20 and the off-bias voltage control circuit 30.

The first control circuit 21 or the second control circuit 31 may include a passive element such as a resistor, a capacitor or a diode, and an RC filter as components not shown in the figure. The first control circuit or the second control circuit may include a Schmitt trigger element configured to tailor a transmission signal. The first control circuit 21 includes a delay line (which can be realized by a delay IC or a buffer circuit) that delays the transmission signal by a certain amount of time, and the second control circuit 31 includes a logical operation circuit that performs a logical operation such as a logical OR or a logical AND on the transmission signal.

Further, the first switching circuit 22 and the second switching circuit 32 have a totem pole circuit structure in which switching elements are disposed on the upper and lower arms as components not shown in the figure, and may perform a two-stage control on outputs according to an input gate control signal. Specifically, the circuit may be configured as a push-pull circuit where the high-side element is an NPN transistor and the low-side element is a PNP transistor as described above, or may have any other configuration.

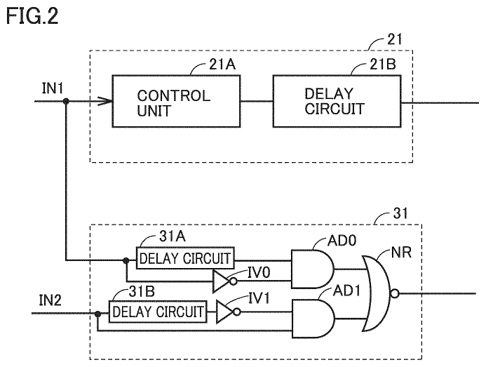

FIG. 2 is a diagram illustrating a specific configuration of the first control circuit 21 and the second control circuit 31 according to the first embodiment.

With reference to FIG. 2, the first control circuit 21 includes a control unit 21A and a delay circuit 21B.

The control unit 21A receives the external drive signal IN1 as an input signal and generates a tailored signal. For example, the control unit 21A may be realized by a capacitor for holding a voltage, a diode element for preventing reverse conduction, and a Schmitt trigger element for tailoring the transmission signal.

The delay circuit 21B receives an output signal from the control unit 21A, delays the output signal by a certain amount of time, and generates a delay signal. For example, the delay circuit 21B may be a delay line that delays the transmission signal by a certain amount of time, and the delay line may be constituted by a logic IC or a buffer element.

By constituting the first control circuit 21 in this manner, the gate control signal input to the first switching circuit 22 illustrated in FIG. 1 is delayed by a certain amount of time based on the external drive signal IN1. The operation of the first switching circuit 22 can also be delayed by the same amount of time in response to the amount of delay of the gate control signal. Therefore, the switching operation of the power semiconductor element 10 is also delayed by the same amount of time. Further, the gate delay amount of the power semiconductor element 10 can be set variable by providing a plurality of terminals for each of the logic IC and the buffer element constituting the delay line, by setting different delay amounts for the logic IC and the buffer element, or by using a jumper pin to switch the connection point of the circuit.

The second control circuit 31 includes delay circuits 31A and 31B, inverters IV0 and IV1, AND circuits AD0 and AD1, and a NOR circuit NR.

The AND circuit ADO receives the external drive signal IN1 via the delay circuit 31A and the external drive signal IN1 via the inverter IV0, and outputs an AND logic operation result to the NOR circuit NR.

The AND circuit AD1 receives the external drive signal IN2 via the delay circuit 31B and the inverter IV1 and the external drive signal IN2 directly, and outputs an AND logic operation result to the NOR circuit NR.

The NOR circuit NR receives inputs from the AND circuits AD0 and AD1, and outputs a NOR logic operation result.

The delay circuits 31A and 31B are configured to generate a delay signal. For example, the delay circuit may be an RC filter which is a general delay time adjustment circuit, or may include a Schmitt trigger element for tailoring a transmission signal. The delay amount of the delay circuit 31A may be different from the delay amount of the delay circuit 31B.

The NOR circuit NR normally outputs an off-bias voltage control signal (“1”).

As a result, the NPN transistor 32A of the second switching circuit 32 is turned on.

On the other hand, when the external drive signal IN1 changes from “1” to “0”, the AND circuit AD0 outputs a one-shot pulse signal proportional to the delay amount of the delay circuit 31A. In response, the NOR circuit NR turns on the PNP transistor 32B of the second switching circuit 32 during the period of the one-shot pulse signal.

When the external drive signal IN2 changes from “0” to “1”, the AND circuit AD1 outputs a one-shot pulse signal proportional to the delay amount of the delay circuit 31B. In response, the NOR circuit NR turns on the PNP transistor 32B of the second switching circuit 32 during the period of the one-shot pulse signal.

The second control circuit 31 is a logical operation circuit that receives two signals of the external drive signals IN1 and IN2, performs a logical operation such as a logical OR or a logical AND on the two signals, and generates a single off-bias voltage control signal from the two output signals. For example, the second control circuit may be constituted by a discrete IC element incorporated with only one element, or may be constituted by a 2-in-1 logic IC having two logic functions. The second control circuit may include at least one AND element and at least one OR element for logical operation.

Due to the provision of the delay circuits 31A and 31B, it is possible to generate an off-bias voltage control signal according to the external drive signal IN1 and the external drive signal IN2, and it is possible to adjust the time of the off-bias voltage control signal.

Specifically, it is possible to determine a timing and a period of applying the deep off-bias voltage Vneg to the gate of the power semiconductor element 10 in response to the delay amount of the delay circuits 31A and 31B. The resistor or the capacitor in the RC filter of each of the delay circuits 31A and 31B may be a variable resistor or a variable capacitor. With such a configuration, it is possible to variably set a timing and a period of applying the deep off-bias voltage Vneg to the power semiconductor element 10.

According to the first embodiment, since the control unit 21A and the delay circuit 21B are provided in the first control circuit 21 included in the gate voltage control circuit 20, and the delay circuits 31A and 31B are provided in the second control circuit 31 included in the off-bias voltage control circuit 30, it is possible to generate an appropriate off-bias level control signal, and it is possible to determine the timing and the period of applying the deep off-bias voltage Vneg to the power semiconductor element 10. As a result, the reliability of the power semiconductor element 10 is improved.

Next, a specific operation of the gate drive circuit 100 according to the first embodiment will be described.

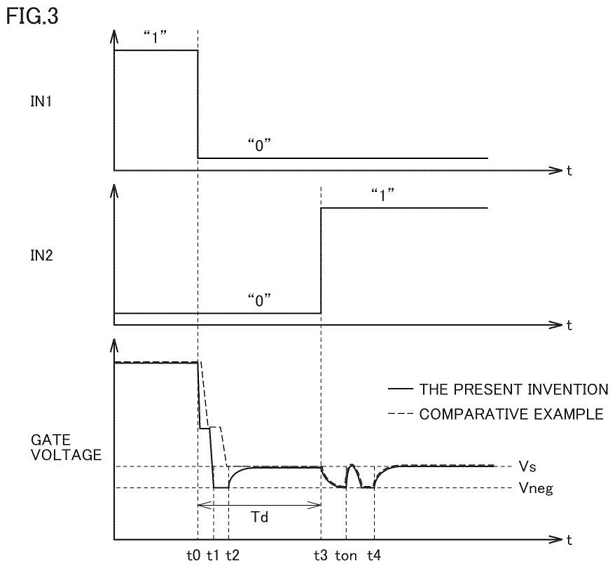

FIG. 3 is a diagram illustrating a timing chart when the gate drive circuit 100 according to the first embodiment controls the gate of the power semiconductor element 10.

With reference to FIG. 3, operation differences between the gate drive circuit 100 according to the first embodiment and the comparative example are illustrated. The horizontal axis represents time, and the vertical axis represents an external drive signal IN1, an external drive signal IN2, and a gate voltage Vgs of the power semiconductor element 10.

At time t0, the external drive signal IN1 changes from “1” to “0”, and in response, the gate drive circuit 100 begins to discharge the gate of the power semiconductor element 10. In other words, the power semiconductor device 10 is turned off. Since the charges of the gate charged during the ON operation are discharged, the gate voltage Vgs of the power semiconductor element begins to drop.

First, the gate voltage Vgs drops sharply from an on-bias voltage Vdd. Next, while a drain-source voltage Vds (not shown) of the power semiconductor element 10 begins to rise, the gate voltage Vgs is maintained at a certain constant voltage value. This period is referred to as a mirror period, and continues until the gate-drain parasitic capacitance, which depends on the drain-source voltage Vds, ceases to change (in general, the mirror period is very short for SiC-MOSFET). After the mirror period ends, the gate voltage Vgs begins to drop again, and reaches the deep off-bias voltage Vneg, which terminates the turn-off operation. Thus, there are great differences between the gate drive circuit according to the first embodiment and the comparative example (the configuration described in PTL 1).

The most significant difference is the presence or absence of the deep off-bias voltage Vneg.

Since the gate drive circuit 100 according to the first embodiment is provided with a function of applying the deep off-bias voltage Vneg to the gate, the speed of turning off the power semiconductor element 10 is faster than the comparative example which is not provided with the function of applying the deep off-bias voltage. In the interval from time to t0 the start of the mirror period and from the end of the mirror period to the end of the turn-off operation, the absolute value of a change rate dVgs/dt of the gate voltage Vgs is larger in the configuration according to the first embodiment than in the configuration of the comparative example.

This effect makes it possible to reduce the turn-off loss of the power semiconductor device 10, which has the advantages of suppressing heat generation of the power conversion apparatus and reducing the size of the cooler.

On the other hand, in the configuration according to the comparative example, since the turn-off operation is performed by the shallow off-bias voltage Vs, it is concerned that the reduction of the turn-off loss of the power semiconductor element 10 is not sufficient. Furthermore, there are differences in the behavior of the gate voltage Vgs after the end of the turn-off operation.

Since the configuration according to the first embodiment has the deep off-bias voltage Vneg, the gate voltage Vgs drops from the shallow off-bias voltage Vs to the deep off-bias voltage Vneg.

In the gate drive circuit 100 according to the first embodiment, the turn-off operation of the power semiconductor element 10 is completed at time t1 when the gate voltage Vgs reaches the deep off-bias voltage Vneg.

According to the configuration of the gate drive circuit 100 according to the first embodiment, since the deep off-bias voltage Vneg is applied to the gate of the power semiconductor element 10 from time t1, which may cause characteristic degradation or failure due to the stress on the gate oxide film as described above, but the period from time t1 to time t2 at which the deep off-bias voltage Vneg begins to return to the shallow off-bias voltage Vs is sufficiently shorter than a dead time period Td (both the upper arm and the lower arm are turned off) set in the inverter circuit of the power conversion apparatus. In other words, the actual stress on the gate oxide film is very small. Therefore, high reliability of the power semiconductor element 10 can be ensured.

In the present embodiment, the deep off-bias voltage Vneg is applied to the gate of the power semiconductor element 10 in the period from time t0 to time t2. This period is defined as a first period. Next, the operations after time t2 will be described.

During the dead time period Td, the gate voltage Vgs of the power semiconductor element 10 is set to the shallow off-bias voltage Vs, and the external drive signal IN1 and the external drive signal IN2 are both set to “0”.

In the present embodiment, the external drive signal IN2 has a function of notifying the timing of a false turn-on of the gate of the power semiconductor element 10, in other words, the turn-on timing of the opposing arm element.

Thus, the external drive signal IN2 changes from “0” to “1” at the end of the dead time period Td.

The gate drive circuit 100 determines that it is time to turn on the opposing arm element of the power semiconductor element 10 based on the change of the external drive signal IN2, and changes the gate voltage Vgs of the power semiconductor element 10 from the shallow off-bias voltage Vs to the deep off-bias voltage Vneg. Then, the opposing arm element is turned on, and thereby the gate voltage Vgs of the power semiconductor element 10 is raised from the deep off-bias voltage Vneg. Since the deep off-bias voltage Vneg is set larger than the raised voltage value of the gate voltage Vgs, the gate voltage Vgs does not exceed 0 V. In other words, there is a sufficient margin for the gate threshold voltage of the power semiconductor element 10.

The period from time t3 to time ton at which the opposing arm element of the power semiconductor element 10 actually starts the turn-on operation coincides with the delay amount of the gate control signal to the opposing arm element. Since it takes time for the deep off-bias voltage Vneg to be applied to the gate voltage Vgs of the power semiconductor element 10, a delay of the gate control signal to the opposing arm element is inserted. This makes it possible to reliably prevent a false turn-on of the gate of the power semiconductor device 10.

At time t4 after the turn-on operation of the opposing arm element of the power semiconductor element 10 is completed, the gate voltage Vgs of the power semiconductor element 10 again begins to return from the deep off-bias voltage Vneg to the shallow off-bias voltage Vs. In other words, the stress on the gate oxide film of the power semiconductor element 10 is very small. In other words, during the period from time t3 to time t4, the deep off-bias voltage Vneg is applied to the gate of the power semiconductor element 10. In the present embodiment, the period from the end of the dead time period Td until the shallow off-bias voltage is applied to the gate of the power semiconductor element 10 is defined as a second period. In other words, the period from time t3 to time t4 is included in the second period.

The gate drive circuit 100 according to the first embodiment can reduce the switching loss by applying a deep off-bias voltage to the power semiconductor device 10, and can improve the reliability of the power semiconductor element 10 by limiting the application time of the deep off-bias voltage to a limited interval within the first period and the second period. As a result, the service life of the power semiconductor element can be prolonged, which makes the power converter system economical.

### Second Embodiment

In a second embodiment, the operation of a gate drive circuit 101 that includes a gate resistance control circuit 40 disposed between the power semiconductor element 10 and the first switching circuit 22 will be described.

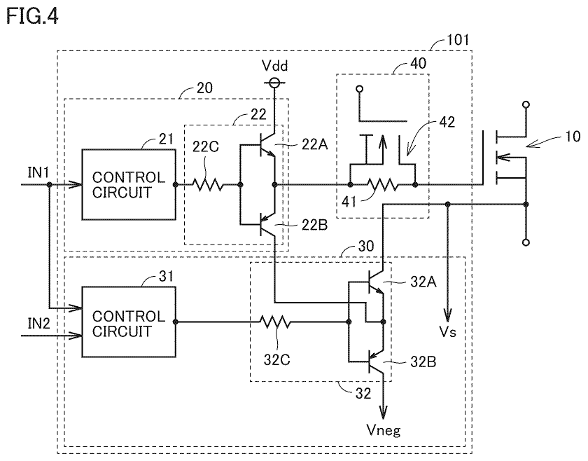

FIG. 4 is a diagram illustrating the gate drive circuit 101 according to the second embodiment.

With reference to FIG. 4, the gate drive circuit 101 is different from the gate drive circuit 100 according to the first embodiment in that the gate resistance control circuit 40 is disposed between the power semiconductor element 10 and the first switching circuit 22. Since the other configurations are the same, the detailed description thereof will not be repeated.

The gate resistance control circuit 40 includes a gate resistor 41 and a bypass switching element 42 connected in parallel to both ends of the gate resistor 41.

The gate resistor 41 adjusts a switching speed, specifically, a turn-on speed and a turn-off speed of the power semiconductor element 10.

When the resistance value of the gate resistor 41 is large, the surge voltage of the drain-source voltage Vds and the electromagnetic noise at the time of switching can be reduced, but the switching loss increases. Conversely, when the resistance value of the gate resistor 41 is small, the relationship between the surge voltage of the drain-source voltage Vds, the electromagnetic noise and the switching loss is opposite to the case where the resistance value is large.

The bypass switching element 42 performs a turn-on operation and a turn-off operation in response to an ON/OFF command of the gate control signal. The bypass switching element 42 is connected in parallel to the gate resistor 41. After the bypass switching element 42 is turned on, a gate current flows through the bypass switching element 42, and after the bypass switching element is turned off, the gate current flows through the gate resistor 41.

The timing at which the bypass switching element 42 according to the second embodiment is turned on to bypass the gate resistor 41 corresponds to the timing at which the off-bias voltage level of the gate is switched between the deep off-bias voltage Vneg and the shallow off-bias voltage Vs.

Specifically, during the first period, the bypass switching element 42 is maintained in the OFF state until the turn-off operation of the power semiconductor element 10 is completed, and the bypass switching element 42 is turned on after the turn-off operation of the power semiconductor element 10 is completed and the off-bias voltage is switched from the deep off-bias voltage Vneg to the shallow off-bias voltage Vs.

As an example, the bypass switching element 42 is turned on during the period from time Tb1 to time Tb2.

Similarly, the timing at which the bypass switching element 42 according to the second embodiment is turned off and switched to the path via the gate resistor 41 is a period from the time when the dead time period Td ends to a time prepared for the turn-on operation of the opposing arm element, in other words, a period from a time when the shallow off-bias voltage Vs is switched to the deep off-bias voltage Vneg to the start of the turn-on operation of the opposing arm element.

Specifically, during the second period, the bypass switching element 42 is maintained in the ON state until the shallow off-bias voltage Vs is switched to the deep off-bias voltage Vneg, and the bypass switching element 42 is turned off before the turn-on operation of the opposing arm element.

For example, the bypass switching element 42 is turned on during the period from time T3 to time Tb3.

By operating the bypass switching element 42 as described above, the bypass path without the gate resistor 41 is utilized only for switching the deep off-bias voltage Vneg and the shallow off-bias voltage Vs to be applied to the gate of the power semiconductor element 10.

As mentioned above in the first embodiment, the second switching circuit 32 operates in conjunction with the first switching circuit 22. In other words, the speed of switching the deep off-bias voltage Vneg and the shallow off-bias voltage Vs depends on the circuit constant of the discharge path of the power semiconductor element 10. In short, if the resistance of the gate resistor 41 is large, the speed of switching the deep off-bias voltage Vneg and the shallow off-bias voltage Vs becomes slow accordingly. In the second embodiment, the bypass path without the gate resistor 41 makes it possible to increase the speed of switching the deep off-bias voltage Vneg and the shallow off-bias voltage Vs. In other words, it is possible to suitably control the level and timing of the off-bias voltage applied to the gate of the power semiconductor element 10.

Further, the gate resistor 41 is effective against the gate false turn-on. This is because if the gate resistor 41 is small (for example, 0 Ω), an oscillation may occur due to a floating inductance component of the gate wiring of the power semiconductor element 10, which may cause a gate false turn-on. In addition, the susceptibility to electromagnetic noise may trigger the gate false turn-on. As a countermeasure against these phenomena, when a gate false turn-on occurs, in other words, when the opposing arm element is turned on, the bypass switching element 42 is turned off to establish a path via the gate resistor 41.

Next, a specific operation of the gate drive circuit 101 according to the second embodiment will be described.

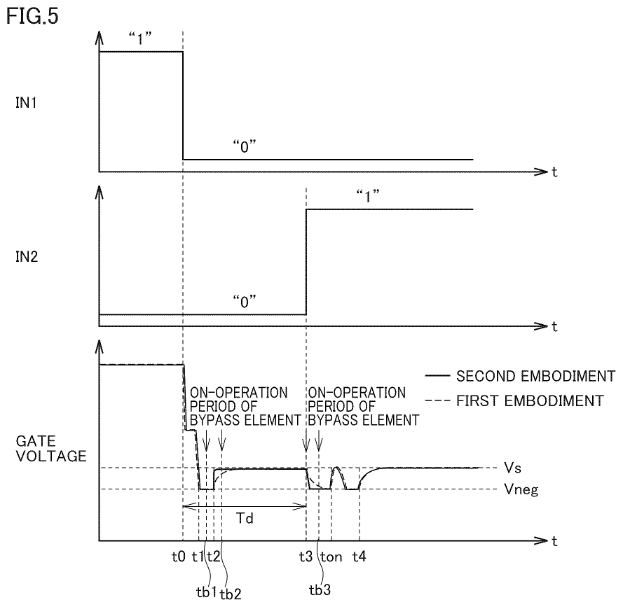

FIG. 5 is a diagram illustrating a timing chart when the gate drive circuit 101 according to the second embodiment controls the gate of the power semiconductor element.

With reference to FIG. 5, since the basic operation of the gate drive circuit 101 according to the second embodiment is the same as the basic operation of the gate drive circuit 100 according to the first embodiment, the detailed description thereof will not be repeated.

At time t0, the power semiconductor element 10 is turned on. As illustrated in the figure, the gate voltage of the power semiconductor device 10 is lowered to the deep off-bias voltage Vneg, and the deep off-bias voltage Vneg is established at time t1. Thereafter, at time t2, the off-bias voltage is switched from the deep off-bias voltage Vneg to the shallow off-bias voltage Vs so as to shorten the application time of the deep off-bias voltage Vneg.

The difference from the gate drive circuit 100 according to the first embodiment is that the bypass switching element 42 is turned on at time tb1 in an interval between time t1 and time t2 included in the first period. With the addition of the operation at time tb1 in the present embodiment, the gate voltage of the power semiconductor element 10 changes at time t2. Specifically, the speed switching from the deep off-bias voltage Vneg to the shallow off-bias voltage Vs is increased, and it is possible to quickly return to the shallow off-bias voltage Vs as illustrated in the figure. Since the off-bias voltage Vs is quickly returned to the shallow off-bias voltage Vs, the application time of the deep off-bias voltage Vneg can be reliably shortened as compared with that in the first embodiment. It should be noted that at time tb2, the bypass switching element 42 is turned off.

After the dead time period Td has elapsed, the external drive signal IN2 indicating the timing of the turn-on operation of the opposing arm element changes from “0” to “1”. In other words, the dead time period Td ends at time t3.

At time t3, the gate voltage of the power semiconductor element 10 is switched again from the shallow off-bias voltage Vs to the negative bias voltage Vneg.

At time t3, the bypass switching element 42 is turned on. Thus, the gate resistor 41 is bypassed, and as a result, the speed of switching from the shallow off-bias voltage Vs to the deep off-bias voltage Vneg becomes faster than that in the first embodiment, and as illustrated in the figure, it is possible to quickly apply the deep off-bias voltage Vneg to the gate of the power semiconductor element 10.

Then, at time tb3, the bypass switching element 42 is turned off.

Subsequently, at time ton, the opposing arm element is turned on, and a gate false turn-on of the power semiconductor element 10 occurs. In the present embodiment, the bypass switching element 42 is turned off at time tb3 within an interval between time t3 and time ton included in the second period.

As described above, with the addition of the operation of the gate resistance control circuit 40 according to the second embodiment at time tb3, it is possible to prevent the gate false turn-on of the power semiconductor element 10 from being caused by the floating inductance and the electromagnetic noise. Specifically, by turning off the bypass switching element 42 to switch to the gate resistor 41, it is possible to obtain a gate false turn-on tolerance equivalent to that of the first embodiment as illustrated in the figure.

In the dead time period Td after time tb2, in other words, in the off-bias period of the power semiconductor element 10, the gate resistance control circuit 40 turns off the bypass switching element 42 to connect the gate resistor 41. As described above, by keeping the gate resistor 41 connected even during the OFF operation of the power semiconductor element 10, it is possible to dampen the oscillation of the gate caused by external factors. As a result, the gate false turn-on of the power semiconductor element 10 can be prevented.

The ON operation period (tb1-tb2, t3-tb3) of the bypass switching element 42 can be set by the components described in the first embodiment. Specifically, it can be realized by combining the RC filter that delays the period from time t0 to time tb1, and the logic operation circuit described in the first embodiment that generates a one-shot pulse using the external drive signal IN1 and the external drive signal IN2. Further, the ON operation period (bypass period) of the bypass switching element 42 can also be set arbitrarily, and the ON operation and the OFF operation can also be switched over a plurality of places.

The gate resistor 41 may be constituted by a circuit element such as a general lead resistor or a chip resistor as long as it has a circuit constant or a power capacity in accordance with the switching operation condition of the power semiconductor element 10, the number of circuit elements constituting the gate resistor 41 may be single or multiple, and the circuit configuration may be serial or parallel. The bypass switching element 42 may be an inexpensive discrete circuit element as long as it can cope with the gate capacitance of the power semiconductor element 10. The bypass switching element 42 desirably has a higher high-speed response. The trade-off relationship holds that the higher the gate threshold voltage, the lower the risk of malfunction, but the lower the high-speed response; on the other hand, the lower the gate threshold voltage, the higher the high-speed response, but the higher the risk of malfunction.

The gate drive circuit 101 according to the second embodiment includes a gate resistance control circuit 40 disposed between the power semiconductor element 10 and the first switching circuit 22, which makes it possible to further shorten the period of the deep off-bias voltage Vneg applied to the gate of the power semiconductor element 10. Furthermore, by speeding up the switching from the shallow off-bias voltage Vs to the deep off-bias voltage Vneg, it is possible to further improve the reliability of the power semiconductor element 10.

Therefore, it is possible to further prolong the service life of the power semiconductor element 10, which makes the power converter system economical.

### Third Embodiment

In a third embodiment, a switching circuit having a configuration different from that of the first embodiment will be described.

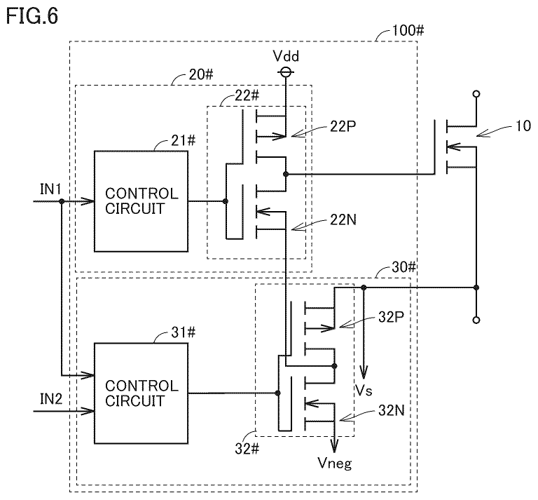

FIG. 6 is a block diagram illustrating a gate drive circuit 100 # of the power semiconductor device according to the third embodiment.

With reference to FIG. 6, the gate drive circuit 100 # differs from the gate drive circuit 100 in that the gate voltage control circuit 20 is replaced with a gate voltage control circuit 20 # and the off-bias voltage control circuit 30 is replaced with an off-bias voltage control circuit 30 #.

Since the other configurations are the same as those of the gate drive circuit 100 according to the first embodiment, the detailed description thereof will not be repeated.

The gate voltage control circuit 20 # differs from the gate voltage control circuit 20 in that the first control circuit 21 is replaced with a first control circuit 21 # and the first switching circuit 22 is replaced with a first switching circuit 22 #.

The off-bias voltage control circuit 30 # differs from the off-bias voltage control circuit 30 in that the second control circuit 31 is replaced with a second control circuit 31 # and the second switching circuit 32 is replaced with a second switching circuit 32 #.

The first switching circuit 22 # includes a PMOSFET 22P on the high side and an NMOSFET 22N on the low side.

The PMOSFET 22P and the NMOSFET 22N are connected in series.

The PMOSFET 22P is connected to the positive voltage source Vdd and is connected to an output node.

The NMOSFET 22N is connected to the output node and an output node of the second switching circuit 32.

The second switching circuit 32 # includes a PMOSFET 32P on the high side and an NMOSFET 32N on the low side.

The PMOSFET 32P and the NMOSFET 32N are connected in series.

The PMOSFET 32P is connected to the source electrode of the power semiconductor element 10 and is connected to the output node. The output node is connected to the first switching circuit 22 #.

The NMOSFET 32N is connected to the output node and the negative voltage source Vneg. The switching circuit according to the third embodiment is particularly effective for a power conversion apparatus to which, for example, a wide bandgap semiconductor is applied and which is applied to a high frequency drive application.

A CMOS circuit constituted by the PMOSFET 22P and the NMOSFET 22N and the PMOSFET 32P and the NMOSFET 32N according to the third embodiment will be described.

Since both the elements of the upper and lower arms are constituted by MOSFETs, the power consumption is lower than that in the case where these elements are constituted by bipolar transistors. In addition, as the switching frequency of the power inverter increases, the number of times of switching the gate drive circuit also increases accordingly. In other words, it is very useful for the high-frequency drive applications described above.

The output line of the PMOSFET 22P and the NMOSFET 22N swings between the power supply voltage Vdd applied to the high side of the PMOSFET 22P and the potential (the shallow off-bias voltage Vs or the deep off-bias voltage Vneg) applied to the low side. Further, a constant drive capability can be obtained regardless of the difference between the input voltage from the power supply voltage and the output voltage of the output line. With such a drive output, it is possible to realize the gate drive circuit 100 # with high drive capability and high stability.

On the other hand, in a general push-pull circuit, the swing range of the output line is narrowed by the gate threshold voltage of the transistor elements on the upper and lower arms. In other words, when the output voltage is outside the swing range, the output of the push-pull circuit becomes floating, indicating an unstable operation.

In the gate drive circuit 100 # according to the third embodiment, the switching circuit is realized by a CMOS circuit, it is possible to obtain high drive capability and high stability. These effects are expected to improve the characteristics of the power semiconductor device 10 and prevent oscillation from being caused by fluctuations in the gate potential.

Although the advantages of the CMOS circuit have been described above, the CMOS circuit may also have disadvantages. At the time of switching the upper and lower arm elements, a through current may flow between the power supply voltage of the high side and the reference potential of the low side. This through current may increase the power consumption of the gate drive circuit 100. The increase in the power consumption makes the CMOS circuit inappropriate for the high-frequency drive operation, which contradicts the above-described advantages.

Therefore, a dead time period between the upper and lower arms may be generated before the PMOSFET 22P and the NMOSFET 22N and the PMOSFET 32P and the NMOSFET 32N. By providing an appropriate dead time period, it is possible to reduce a through current flowing into the CMOS circuit. For example, the signals applied to the gates of the PMOSFET 22P and the NMOSFET 22N and the PMOSFET 32P and the NMOSFET 32N may be controlled independently.

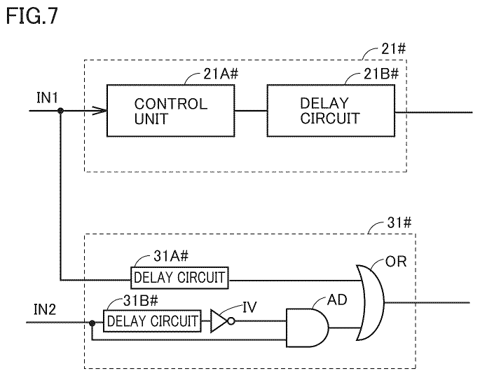

FIG. 7 is a diagram illustrating a specific configuration of a first control circuit 21 # and a second control circuit 31 # according to the third embodiment. Since the basic element configuration and the like are the same as those of the first control circuit 21 and the second control circuit 31 illustrated in FIG. 2, the description thereof will not be repeated.

With reference to FIG. 7, the first control circuit 21 # includes a control unit 21A # and a delay circuit 21B #.

The second control circuit 31 # includes delay circuits 31A # and 31B #, an inverter IV, an AND circuit AD, and an OR circuit OR.

The AND circuit AD receives the external drive signal IN2 via the delay circuit 31B # and the inverter IV or receives the external drive signal IN2 without any elements or additional circuits, and outputs an AND logic operation result to the OR circuit OR.

The OR circuit OR receives the external drive signal IN1 via the delay circuit 31A # or receives an input from the AND circuit AD, and outputs an OR logic operation result.

The delay circuits 31A # and 31B # are configured to generate a delay signal. For example, the delay circuit may be an RC filter which is a general delay time adjustment circuit, or may include a Schmitt trigger element for tailoring a transmission signal. The delay amount of the delay circuit 31A # may be different from the delay amount of the delay circuit 31B #.

The OR circuit OR outputs an off-bias voltage control signal (“1”) when the power semiconductor element 10 is in a steady ON state with no switching operation, and outputs an off-bias voltage control signal (“0”) when the power semiconductor element is in a steady OFF state with no switching operation.

As a result, the PMOSFET 32P of the second switching circuit 32 # repeats the ON operation and the OFF operation at a constant cycle.

On the other hand, the output of the off-bias voltage control signal changes complicatedly during the transient time of the switching operation. When the external drive signal IN1 changes from “1” to “0”, the OR circuit OR maintains the output of “1” for a period proportional to the delay amount of the delay circuit 31A #. In response, the OR circuit OR turns on the NMOSFET 32N of the second switching circuit 32 # in response to the period where the output is maintained at “1”.

When the external drive signal IN2 changes from “0” to “1”, the AND circuit AD outputs a one-shot pulse signal proportional to the delay amount of the delay circuit 31B #. Accordingly, the OR circuit OR turns on the NMOSFET 32N of the second switching circuit 32 # in response to the one-shot pulse signal.

According to the present embodiment, the PMOSFET 22P and the NMOSFET 22N are provided in the first control circuit 21 included in the gate voltage control circuit 20, and the PMOSFET 32P and the NMOSFET 32N are provided in the second control circuit 31 included in the off-bias voltage control circuit 30. As a result, it is possible to suppress gate oscillation or the like in high-frequency applications, while maintaining high characteristics of the power semiconductor element 10.

The configuration of the gate resistance control circuit 40 according to the second embodiment may be further applied.

### Fourth Embodiment

In a fourth embodiment, the voltage level control of the off-bias voltage applied to the gate of the power semiconductor element 10 will be described.

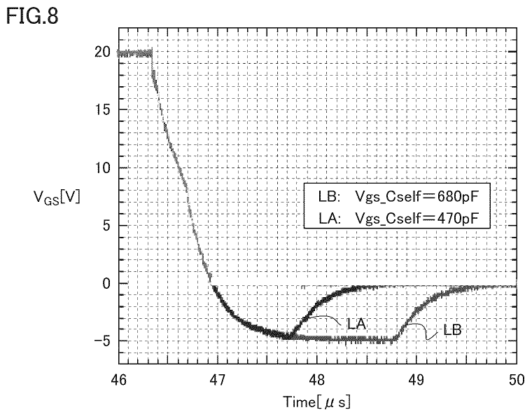

FIG. 8 is a diagram illustrating a waveform of the gate voltage Vgs of the SiC-MOSFET to which the gate drive circuit 100 of the present disclosure is applied.

FIG. 8 illustrates a case where the period of applying the deep off-bias voltage is adjusted.

In the present embodiment, the on-bias voltage of the gate is set to +20 V, the shallow off-bias voltage Vs is set to 0 V, and the deep off-bias voltage Vneg is set to −5 V. The drive conditions were the same except for the period of the deep off-bias voltage Vneg.

The waveform LA shows a case where the application period of the off-bias voltage is shorter than that of the waveform LB. In other words, the two waveforms have different periods of the deep off-bias voltage Vneg.

The period of the deep off-bias voltage Vneg is adjusted by adjusting the time constant of the RC filter constituting the delay circuit included in the off-bias voltage control circuit 30.

Specifically, the delay amount of the delay circuit is adjusted by adjusting the capacitance of the capacitor, thereby adjusting the period during which the off-bias voltage is applied.

Specifically, in the case where two types of capacitance of 470 pF and 680 pF are provided as the capacitance of the capacitor in the delay circuit, the period of the deep off-bias voltage Vneg can be set to a shorter period by setting the capacitance of the capacitor to “470 pF”. Thus, it is possible to further reduce the stress on the gate oxide film.

For example, if the capacitor is a variable capacitor, it is possible to adjust the period of the off-bias voltage Vneg to an optimum period by setting the capacitance of the capacitor to an optimum capacitance.

### Fifth Embodiment

In a fifth embodiment, another aspect relating to the operation of the gate drive circuit 100 including the gate resistance control circuit 40 according to the second embodiment will be described.

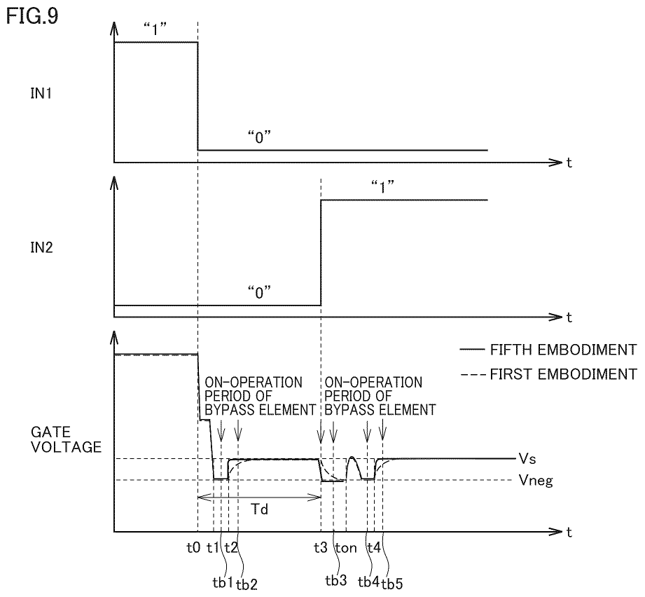

FIG. 9 is a diagram illustrating a timing chart when a gate drive circuit 101 according to the fifth embodiment controls the gate of the power semiconductor element.

With reference to FIG. 9, the basic operation of the gate drive circuit 101 according to the fifth embodiment is the same as that of the gate drive circuit 100 according to the second embodiment, and therefore the detailed description thereof will not be repeated.

As compared with the timing chart of FIG. 5, the bypass switching element 42 included in the gate resistance control circuit 40 described with reference to FIG. 3 is turned on during an interval between time tb4 and time tb5 within the period between time ton and time t4.

By this operation, as illustrated in FIG. 9, the gate voltage Vgs of the power semiconductor element 10 is quickly switched from the deep off-bias voltage Vneg to the shallow off-bias voltage Vs. As a result, the period of applying the deep off-bias voltage Vneg to the gate of the power semiconductor element 10 is reliably shortened.

Time tb4 at which the bypass switching element 42 is turned on is set to be between the time when the turn-on operation of the opposing arm element of the power semiconductor element 10 is completed and time t4. With this setting, it is possible to suppress oscillation of the gate of the power semiconductor element 10 during the turn-on period of the opposing arm element, and to avoid the risk of causing a false turn-on. In addition, it is also possible to obtain the effect of shortening the period of applying the deep off-bias voltage Vneg to the power semiconductor element 10.

The present embodiment can be realized by providing additional elements to the configuration of FIG. 4. The additional element is provided with a function to control the gate resistance control circuit 40 so as to reduce the value of the gate resistor 41, and to determine time tb3 at which the bypass switching element 42 is turned on.

Specifically, time information of time ton at which the opposing arm element of the power semiconductor element 10 is turned on is utilized to determine time tb4.

For example, the time information of time ton may be acquired by providing an overvoltage detection circuit or a voltage change rate dVds/dt detection circuit between the drain electrode and the source electrode of the power semiconductor element 10. Alternatively, a gate current detection circuit may be connected in series with and adjacent to the gate resistance control circuit 40. By synchronizing the detection information of these detection circuits with the signal of the second control circuit 31 included in the off-bias voltage control circuit 30, it is possible to adjust time tb3 to an appropriate time.

Alternatively, the second control circuit 31 included in the off-bias voltage control circuit 30 may be provided with a state timer with preset times. For example, time tb4 may be set by measuring a time taken to turn on the opposing arm element of the power semiconductor element 10 in an experiment performed in advance.

In the fifth embodiment, a time at which the bypass switching element 42 included in the gate resistance control circuit 40 is turned on is added to the configuration according to the second embodiment. As a result, the period of applying the deep off-bias voltage Vneg to the gate of the power semiconductor element 10 can be shortened more suitably.

### Sixth Embodiment

In a sixth embodiment, the configuration of an integrated drive circuit 102 will be described.

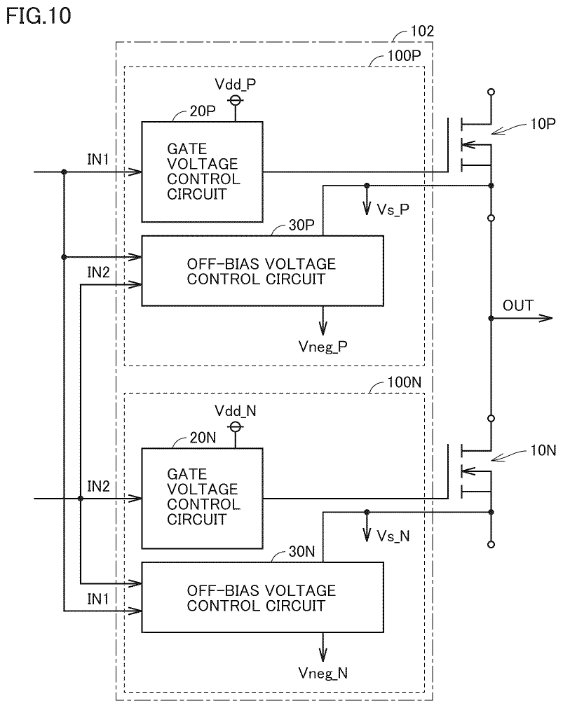

FIG. 10 is a block diagram illustrating the integrated drive circuit 102 according to the sixth embodiment.

With reference to FIG. 10, the integrated drive circuit 102 according to the sixth embodiment is different from the gate drive circuit 100 in that it is an integrated circuit incorporated with two drive circuits of a gate drive circuit 100P and a gate drive circuit 100N.

The integrated drive circuit means that, for example, the upper arm and the lower arm are integrated and the power semiconductor elements are connected in series, and can be applied to a half-bridge circuit which is frequently seen in a power module in which the power semiconductor elements are packaged in 2-in-1 as illustrated in FIG. 10.

The power semiconductor element 10P and the power semiconductor element 10N connected in series to each other, i.e., the power semiconductor elements in the upper and lower arms, are driven by a single drive circuit, i.e., the integrated drive circuit 102.

The input signals are the external drive signal IN1 and the external drive signal IN2.

As described in the first embodiment, the external drive signal may be a logic pulse signal as long as the external drive signal IN is set to “1” during a period when a corresponding power semiconductor element should be turned on, and the external drive signal IN is set to “0” during a period when a corresponding power semiconductor element should be turned off.

In the present embodiment, the external drive signal IN1 controls the gate of the power semiconductor element 10P of the upper arm, and is input to the gate voltage control circuit 20P. The external drive signal IN2 controls the gate of the power semiconductor element 10N of the lower arm, and is input to the gate voltage control circuit 20N.

As described in the first embodiment, the external drive signal IN2 for notifying the timing of turning on the power semiconductor element 10N of the lower arm, which is one of the opposing arm elements, is input to the off-bias voltage control circuit 30P. The external drive signal IN1 for notifying the timing of turning on the power semiconductor element 10P of the upper arm, which is the other one of the opposing arm elements, is input to the off-bias voltage control circuit 30N.

With such a configuration, the integrated drive circuit performs the same operation as the gate drive circuit 100 described in the first embodiment.

The gate drive circuit 100P and the gate drive circuit 100N included in the integrated drive circuit 102 basically have the same circuit configuration, but if there are variations in the element characteristics between the power semiconductor elements 10P and 10N of the upper and lower arms, the off-bias voltage control circuits 30P and 30N may perform fine adjustment internally. For example, by adjusting the timing of the deep off-bias voltage Vneg and the shallow off-bias voltage Vs with respect to the off-bias voltage control circuit 30P and the off-bias voltage control circuit 30N, a more suitable operation of the power semiconductor elements can be achieved.

In the sixth embodiment, the external drive signal IN1 and the external drive signal IN2 are isolated by an isolating element having a sufficient dielectric strength, for example, an insulating element such as a photocoupler or an insulating transformer inside the gate voltage control circuit 20P and the gate voltage control circuit 20N, and inside the off-bias voltage control circuit 30P and the off-bias voltage control circuit 30N. The isolating element may be an isolator IC having a plurality of inputs and a plurality of outputs, and in such a configuration, the insulation process of the gate voltage control circuit 20P and the off-bias voltage control circuit 30P can be shared.

A positive voltage source Vdd_P to be supplied to the gate drive circuit 100P must be an insulated power source, and the potential of the positive voltage source Vdd_P is a floating potential with respect to the ground potential. Each of the deep off-bias voltage Vneg_P and the shallow off-bias voltage Vs_P included in the gate drive circuit 100P is also a floating potential with respect to the ground potential. Since the positive voltage source Vdd_P is a floating power supply, for example, a three-terminal regulator may generate an arbitrary potential, an appropriate deep off-bias voltage Vneg_P and an appropriate shallow off-bias voltage Vs_P.

With such a configuration, the power semiconductor element 10P which corresponds to the upper arm element in the half bridge circuit can be electrically and safely operated by the gate drive circuit 100P included in the integrated drive circuit 102.

In the present embodiment, the configuration of a half bridge circuit has been described, but the method according to the fifth embodiment can also be applied to, for example, a power module for a three-phase inverter in which the power semiconductor elements are packaged in a 6-in-1 configuration.

The configuration according to the sixth embodiment includes an integrated drive circuit 102 in which the drive circuit of the upper arm and the drive circuit of the lower arm are integrated to drive the upper and lower arm elements in the half-bridge circuit of the power conversion apparatus. As a result, the power semiconductor element 10P of the upper arm and the power semiconductor element 10N of the lower arm can be driven with a simple circuit configuration without requiring extra addition or complicated processing of external drive signals.

### Seventh Embodiment

In a seventh embodiment, the power conversion apparatus according to the above-described embodiment is applied to a power conversion system. Although the present disclosure is not limited to a specific power conversion system, in the seventh embodiment, the present disclosure relates to a power conversion system to which a three-phase inverter is applied.

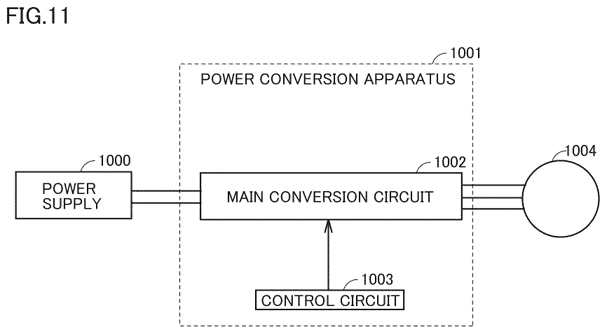

FIG. 11 is a block diagram illustrating a configuration of a power conversion system according to the seventh embodiment.

With reference to FIG. 11, the power conversion system according to the seventh embodiment includes a power supply 1000, a power conversion apparatus 1001, and a load 1004. The power supply 1000 is a DC power supply that supplies DC power to the power conversion apparatus 1001. The power supply 1000 can be constituted by various types of power supplies, and may be constituted by, for example, a DC system, a solar cell, a storage battery, a rectifier circuit or an AC/DC converter connected to an AC system. In addition, the power supply 1000 may be constituted by a DC/DC converter that converts DC power output from a DC system to a specific power.

The power conversion apparatus 1001 is a three-phase inverter connected between the power supply 1000 and the load 1004, and is configured to convert DC power supplied from the power supply 1000 into AC power and supply the AC power to the load 1004. The power conversion apparatus 1001 includes a main conversion circuit 1002 that converts DC power into AC power and outputs the AC power, and a control circuit 1003 that outputs a control signal for controlling the main conversion circuit 1002 to the main conversion circuit 1002.

The load 1004 is a three-phase electric motor driven by the AC power supplied from the power conversion apparatus 1001. The load 1004 is not limited to a specific application, and may be any electric motor mounted on various electric devices, and may be used as, for example, an electric motor for a hybrid vehicle, an electric vehicle, a railroad vehicle, an elevator, or an air-conditioner.

Hereinafter, the power conversion apparatus 1001 will be described in detail. The main conversion circuit 1002 includes a power semiconductor element and a freewheeling diode (not shown), converts DC power supplied from the power supply 1000 into AC power by switching the power semiconductor element, and supplies the AC power to the load 1004.

Although the main conversion circuit 1002 may have various specific circuit configurations, the main conversion circuit 1002 according to the embodiment is a two-level three-phase full-bridge circuit, and can be constituted by six power semiconductor elements and six freewheeling diodes connected in reverse parallel to each other. Every two of the six power semiconductor elements are connected in series to form upper and lower arms, and each upper arm or each lower arm forms a phase (U phase, V phase, W phase) of the full bridge circuit. The output terminals of the upper and lower arms, in other words, the three output terminals of the main conversion circuit 1002 are connected to the load 1004.

The gate drive circuit described in the first to sixth embodiments and configured to drive each power semiconductor element may be applied to the main conversion circuit 1002.

The gate drive circuit generates a gate control signal that drives the power semiconductor element of the main conversion circuit 1002, and supplies the gate control signal to the control electrode of the power semiconductor element of the main conversion circuit 1002. Specifically, the control circuit 1003 outputs an external drive signal for turning on the power semiconductor element and an external drive signal for turning off the power semiconductor element to the control electrode of each power semiconductor element. When the switching element is maintained at the ON state, the external drive signal is a voltage signal (ON signal) equal to or higher than the threshold voltage of the power semiconductor element, and when the switching element is maintained at the OFF state, the external drive signal is a voltage signal (OFF signal) equal to or lower than the threshold voltage of the power semiconductor element.

The control circuit 1003 controls the power semiconductor element of the main conversion circuit 1002 so that the desired power is supplied to the load 1004.

Specifically, the control circuit calculates a time (ON time) during which each power semiconductor element of the main conversion circuit 1002 should be turned on based on the power to be supplied to the load 1004. For example, the main conversion circuit 1002 may be controlled by a PWM control that modulates the ON time of the power semiconductor element according to the voltage to be output. Then, a control command (external drive signal) is output to a gate drive circuit included in the main conversion circuit 1002 so that an ON signal is output to the power semiconductor element that should be turned on or an OFF signal is output to the power semiconductor element that should be turned off at each time point.

In the power conversion apparatus according to the present embodiment, since the gate drive circuit described above that constitutes the main conversion circuit 1002 is applied, it is possible to improve reliability.

In the present embodiment, the present disclosure is applied to a two-level three-phase inverter, but the present disclosure is not limited thereto, and it can be applied to various types of power conversion apparatuses. In the present embodiment, a two-level power conversion apparatus is used, but a three-level or multi-level power conversion apparatus may be used, and the present disclosure may be applied to a single-phase inverter which supplies electric power to a single-phase load. The present disclosure can also be applied to a DC/DC converter or an AC/DC converter which supplies electric power to a DC load or the like.

In addition, the power conversion apparatus to which the present disclosure is applied is not limited to the case where the load is an electric motor, and may be used as a power supply device of an electric discharge machine, a laser cutting machine, an induction heating cooker, or a non-contact power supply system, or may be also used as a power conditioner of a photovoltaic power generation system, a power storage system, or the like.

It should be understood that the embodiments disclosed herein are illustrative and non-restrictive in all respects. Furthermore, it goes without saying that there is no problem to suitably combine a plurality of embodiments, and it is desirable to efficiently and economically utilize the power conversion apparatus by further enhancing the effects of each embodiment.

The scope of the present invention is defined by the terms of the claims rather than the description of the embodiments above, and is intended to include any modifications within the scope and meaning equivalent to the terms of the claims.

### REFERENCE SIGNS LIST

10, 10N, 10P: power semiconductor element; 20, 20N, 20P: gate voltage control circuit; 21: first control circuit; 22: first switching circuit; 30, 30N, 30P: off-bias voltage control circuit; 31: second control circuit; 32: second switching circuit; 40: gate resistance control circuit; 41: gate resistor; 42: bypass switching element; 100, 100N, 100P, 101: gate drive circuit; 102: integrated drive circuit; 1000: power supply; 1001: power conversion apparatus; 1002: main conversion circuit; 1003: control circuit; 1004: load.

1. A semiconductor device comprising:
a gate voltage control circuit that applies an on-bias voltage and an off-bias voltage to a gate terminal of a power semiconductor element according to a first drive signal; and
an off-bias voltage control circuit that adjusts a voltage level of the off-bias voltage according to the first drive signal and a second drive signal and controls a period of applying the adjusted off-bias voltage.

2. The semiconductor device according to claim 1, wherein
the off-bias voltage control circuit adjusts the voltage level of the off-bias voltage in a first period in which the off-bias voltage is applied according to the first drive signal, and adjusts the voltage level of the off-bias voltage in a second period in which the off-bias voltage is applied according to the second drive signal.

3. The semiconductor device according to claim 2, wherein
the second drive signal is a control signal for applying an on-bias voltage and an off-bias voltage to a gate terminal of a power semiconductor element provided on an opposing arm which is connected in series with the power semiconductor element, and
the second period includes a turn-on operation completion period of the power semiconductor element provided on the opposing arm after a dead time period.

4. The semiconductor device according to claim 1, wherein
the off-bias voltage control circuit sets a first off-bias voltage to a second off-bias voltage that is lower than the first off-bias voltage according to the first and second drive signals.

5. The semiconductor device according to claim 1, further comprising:
a gate resistance control circuit that is provided between the power semiconductor device and the gate voltage control circuit and configured to control a gate resistance of the power semiconductor device.

6. The semiconductor device according to claim 5, wherein
the gate resistance control circuit controls the gate resistance when the voltage level of the off-bias voltage is being adjusted.

7. The semiconductor device according to claim 6, wherein
the gate resistance control circuit increases the gate resistance before the voltage level of the off-bias voltage is changed, and decreases the gate resistance when the voltage level of the off-bias voltage is being adjusted.

8. The semiconductor device according to claim 5, wherein
the gate resistance control circuit includes a resistance element that is provided between the power semiconductor element and the gate voltage control circuit, and a bypass circuit that bypasses the resistance element.

9. The semiconductor device according to claim 1, wherein
the off-bias voltage control circuit includes:
a first delay circuit that delays the first drive signal;
a second delay circuit that delays the second drive signal;
a logic circuit that generates a switching signal based on a combination of a delay signal from the first delay circuit and a delay signal from the second delay circuit; and
a switching circuit that adjusts the voltage level of an off-bias voltage based on the switching signal.

10. A power conversion apparatus comprising:
a first power semiconductor element;
a second power semiconductor element provided on an opposing arm which is connected in series to the first power semiconductor element;
a first gate drive circuit provided for the first power semiconductor element and configured to drive the first power semiconductor element according to a first drive signal; and
a second gate drive circuit provided for the second power semiconductor element and configured to drive the second power semiconductor element according to a second drive signal,
each of the gate drive circuits including:
a gate voltage control circuit that applies an on-bias voltage and an off-bias voltage to a gate terminal of a corresponding power semiconductor element according to a corresponding drive signal; and
an off-bias voltage control circuit that adjusts a voltage level of an off-bias voltage according to the first and second drive signals and controls a period of applying the adjusted off-bias voltage.
